(19) United States
(12) Patent Application Publication
(10) Pub. No.: US 2017/0075665 A1
(43) Pub. Date: Mar. 16, 2017

(54) PROGRAM INFORMATION GENERATION SYSTEM, METHOD, AND COMPUTER PROGRAM

(71) Applicant: Kabushiki Kaisha Toshiba, Minato-ku (JP)

(72) Inventors: Mayuko KOEZUKA, Ota (JP); Nobuaki TOJO, Tachikawa (JP); Hidenori MATSUZAKI, Fuchu (JP); Akira KURODA, Yokohama (JP)

(73) Assignee: Kabushiki Kaisha Toshiba, Minato-ku (JP)

(21) Appl. No.: 15/257,197

(22) Filed: Sep. 6, 2016

(30) Foreign Application Priority Data
Sep. 10, 2015 (JP) 2015-178902

(51) Int. Cl. G06F 9/45

(52) U.S. Cl. CPC G06F 8/433; G06F 8/443; H04L 67/42

(57) ABSTRACT

A call tree generation unit generates a first call tree and a second call tree from a single piece of source code based on running information. The first call tree includes at least one first nodes associated with at least one first scopes. The second call tree includes at least one second nodes associated with at least one second scopes. A node information generation unit generates, based on scope correspondence information, the first call tree, and the second call tree, node correspondence information that indicates correspondence between the first node and the second node.

### CROSS-REFERENCE TO RELATED APPLICATIONS

This application is based upon and claims the benefit of priority from Japanese Patent Application No. 2015-178902, filed on Sep. 10, 2015; the entire contents of which are incorporated herein by reference.

### FIELD

Embodiments described herein relate generally to program information generation systems, methods, and computer programs.

### BACKGROUND

A known system that generates information indicating the status of execution of a program is employed in order, for example, to develop or inspect a program. One known system, for example, generates a plurality of call trees (tree structures) respectively from a plurality of pieces of running information (trace) of a plurality of programs and identifies a common call tree from among the generated call trees, each of the call trees corresponding to each of the pieces of running information.

In some case, check of relation among a plurality of call trees generated from a single piece of running information of a program may be necessary. Such a check cannot be achieved by a system that generates a single call tree from a single piece of source code.

### BRIEF DESCRIPTION OF THE DRAWINGS

FIG. 1 is a diagram illustrating an exemplary hardware configuration of a program information generation system according to a first embodiment;

FIG. 2 is a diagram illustrating an exemplary internal configuration of an information processing terminal and a server in the first embodiment;

FIG. 3 is a diagram illustrating an exemplary functional configuration of the program information generation system in the first embodiment;

FIG. 4 is a flowchart illustrating exemplary steps of processing performed by the program information generation system in the first embodiment;

FIG. 5 is a diagram illustrating an exemplary relation between source code and scopes in the first embodiment;

FIG. 6 is a diagram illustrating exemplary running information in the first embodiment;

FIG. 7 is a diagram illustrating exemplary scope correspondence information in the firs embodiment;

FIG. 8 is a diagram illustrating an exemplary high-order call tree in the first embodiment;

FIG. 9 is a diagram illustrating an exemplary low-order call tree in the first embodiment;

FIG. 10 is a flowchart illustrating an exemplary procedure for generating the high-order call tree or the low-order call tree in the first embodiment;

FIG. 11 is a diagram illustrating exemplary node correspondence information in a first example of the first embodiment;

FIG. 12 is a flowchart illustrating an exemplary procedure for generating the node correspondence information in the first embodiment;

FIG. 13 is a diagram illustrating exemplary node correspondence information in a second example of the first embodiment;

FIG. 14 is a diagram illustrating exemplary node correspondence information in a third example of the first embodiment;

FIG. 15 is a diagram Illustrating exemplary node correspondence information in a fourth example of the first embodiment;

FIG. 16 is a diagram illustrating exemplary first high-order call tree, second high-order call tree, scope correspondence information, and node correspondence information generated by a program information generation system according to a second embodiment;

FIG. 17 is a flowchart illustrating an exemplary procedure for generating a high-order call tree or a low-order call tree in a third embodiment; and

FIG. 18 is a diagram illustrating an exemplary high-order call tree generated in the third embodiment.

### DETAILED DESCRIPTION

### First Embodiment

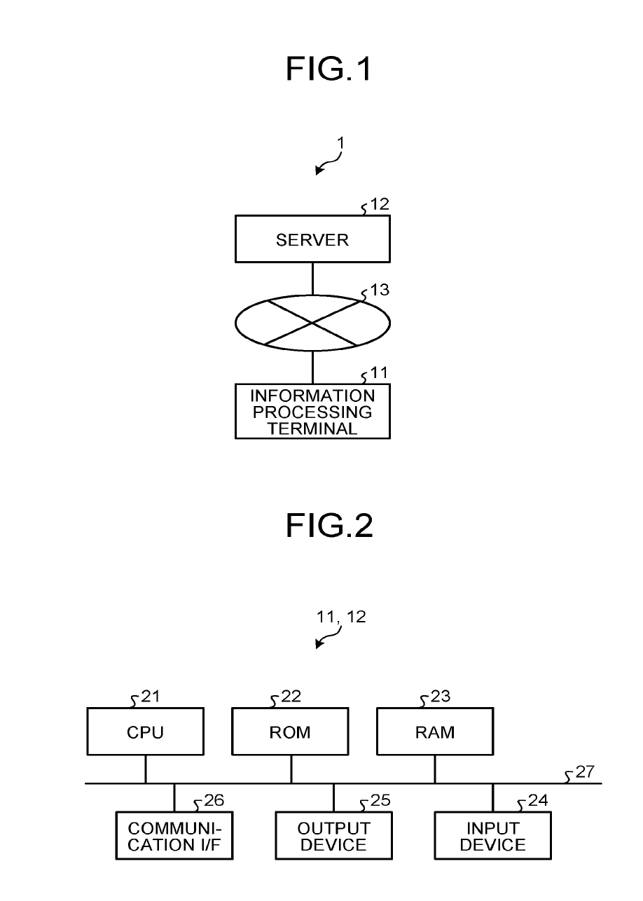

FIG. 1 is a diagram illustrating an exemplary hardware configuration of a program information generation system 1. The program information generation system 1 in the first embodiment includes an information processing terminal 11, a server 12, and a network 13. The information processing terminal 11 may, for example, be a personal computer (PC), a tablet, or a smartphone used by a user. The server 12 may, for example, be a server computer controlled by an administrator of the program information generation system 1. The information processing terminal 11 and the server 12 are connected to each other via the network 13 that may, for example, be the Internet or a local area network (LAN). While FIG. 1 illustrates one information processing terminal 11 and one server 12, both or either one of the information processing terminal 11 and the server 12 may be provided in plural.

FIG. 2 illustrates an exemplary internal configuration of the information processing terminal 11 and the server 12. The information processing terminal 11 and the server 12 each include a central processing unit (CPU) 21, a read only memory (ROM) 22, a random access memory (RAM) 23, an input device 24, an output device 25, a communication interface (I/F) 26, and a bus 27. The CPU 21 performs prescribed arithmetic operations using the RAM 23 as a work area and in accordance with a control program stored in, for example, the ROM 22. The input device 24 may, for example, be a keyboard, a mouse, or a touch panel that can be used for inputting information externally. The output device 25 may, for example, be a display or a printer that can be used for outputting internally generated information to an outside source. The communication I/F 26 enables transmission and reception of information to and from an external device over the network.

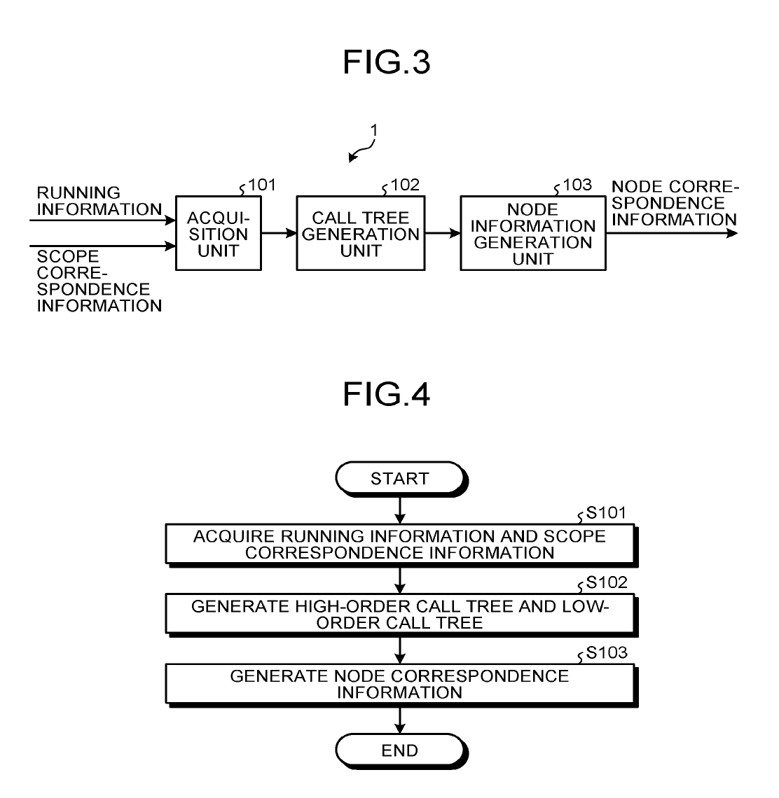

FIG. 3 is a diagram illustrating an exemplary functional configuration of the program information generation system 1 in the first embodiment. The program information generation system 1 includes an acquisition unit 101, a call tree generation unit 102, and a node information generation unit 103.

The acquisition unit 101 acquires running information and scope correspondence information. The running information indicates an execution sequence of a plurality of scopes set within source code to be inspected. The scope indicates a continuous section in a processing by the source code. The scope may, for example, be an extent corresponding to a function, a loop processing within a function, a branch processing within a function, or the like. Furthermore, the scope may, for example, be an extent corresponding to a continuous section not included in a loop or branch processing within a function. The scope is not limited to the foregoing and may be set in compliance with the mode of the source code as appropriate. The scope may be set, for example, with a file name or a line number indicating a continuous section in the source code. The scope correspondence information indicates an inclusion relation (parent-child relation or call relation) among a plurality of scopes. The acquisition unit 101 may be configured through cooperation of the CPU 21, the control program stored in the ROM 22 or the RAM 23, a logic integrated circuit (IC), the RAH 23 used as a work area, and the like. The term “acquisition”, as used herein, includes reception of data from an outside source and internal generation of data. That is, the running information and the scope correspondence information may be generated by any system (device) other than the program information generation system 1 or within the program information generation system 1. A method for generating the running information and the scope correspondence information is not limiting, and the running information and the scope correspondence information may be generated using a well-known or novel technique, as appropriate.

The call tree generation unit 102 generates a plurality of different call trees from a single piece of source code. The call tree is information indicating an inclusion relation among one or more scopes. The call tree may, for example, be a directed graph formed of a plurality of nodes uniquely associated with each of scopes, an edge as a directed segment connecting the nodes, and the like. The call tree generation unit 102 in the embodiment generates a high-order call tree (first call tree) and a low-order call tree (second call tree). The high-order call tree includes, as components thereof, a node (high-order node: first node) corresponding to scope (high-order scope: first scope) that do not have any scope that includes itself, that is, there is no scope that includes the high-order scope. The high-order call tree indicates an inclusion relation among the plurality of high-order scopes. The low-order call tree includes, as components thereof, a node (low-order node: second node) corresponding to a scope (low-order scope: second scope) that has a scope that includes itself, that is, there is a scope that includes the low-order scope. The low-order call tree indicates an inclusion relation among the plurality of low-order scopes. The call tree generation unit 102 may be configured through cooperation of the CPU 21, the control program, the logic IC, the RAM 23, and the like.

The node information generation unit 103 generates node correspondence information that indicates correspondence between the high-order nodes and the low-order nodes on basis of the scope correspondence information, the high-order call tree, and the low-order call tree. That is, the node correspondence information indicates relations between the high-order call trees and the low-order call trees generated from a single piece of source code. The node information generation unit 103 may be configured through cooperation of the CPU 21, the control program, the logic IC, the RAM 23, and the like.

FIG. 4 is a flowchart illustrating exemplary steps of processing performed by the program information generation system 1. The acquisition unit 101 acquires the running information and the scope correspondence information (S101). The call tree generation unit 102 generates the high-order call tree and the low-order call tree on the basis of the running information 102). The node information generation unit 103 generates the node correspondence information on the basis of the scope correspondence information, the high-order call tree, and the low-order call tree 103).

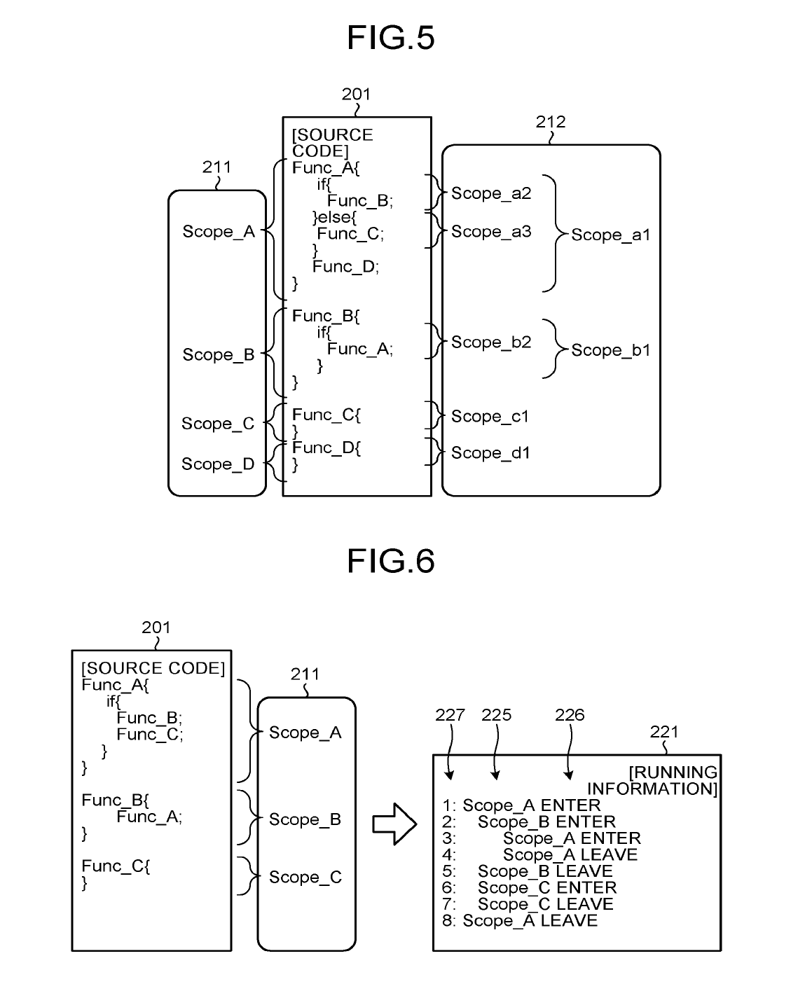

FIG. 5 is a diagram illustrating an exemplary relation between source code 201 and scopes (high-order scopes 211 and low-order scopes 212). The source code 201 in the first embodiment includes four functions of Func_A, Func_B, Func_C, and Func_D. The function Func_A includes branch processing of if{Func_B;} and loop processing of else{Func_C;}. The function Func_B includes branch processing of if{Func_A;}.

In the example illustrated in FIG. 5, scopes of Scope_A, Scope_B, Scope_C, and Scope_D are set as the high-order scopes 211. The Scope_A is associated with the function of Func_A. The Scope_B is associated with the function of Func_B. The Scope_C is associated with the function of Func_C. The Scope_D is associated with the function of Func_D. These high-order scopes 211 do not each have any scope that includes itself.

As the low-order scopes 212, scopes of Scope_a2, Scope_a3, Scope_b2, Scope_a1, Scope_b1, Scope_c1, and Scope d1 are set. The Scope_a2 is associated with the branch processing of if{Func_B;} within the function of Func_A. The Scope_a3 is associated with the loop processing of else{Func_C;} within the function of Func_A. The Scope_b2 is associated with the branch processing of if{Func_A;} within the function of Func_B. The Scope_a1 is associated with a continuous section not including the branch processing or loop processing within the function of Func_A. The Scope_b1 is associated with a continuous section not including the branch processing within the function of Func_B. The Scope_c1 is associated with a continuous section not including the branch processing within the function of Func_C. The Scope_d1 is associated with a continuous section not including the branch processing within the function of Func_D. These low-order scopes 212 each have a scope (including the high-order scope) that includes itself.

FIG. 6 is a diagram illustrating exemplary running information 221. The running information 221 illustrated in the present example is associated with part of the scopes (Scope_A, Scope_B, and Scope_C) excerpted from the high-order scopes 211 of the source code 201. The running information 221 illustrated in the present example includes a scope ID 5, status information 226, and period information 227.

The scope ID 225 represents information associated uniquely with each scope. In the present example, the scope ID 225 is text indicating a scope name. The text is, however, illustrative and not limiting. The scope ID 225 may also, for example, be a numeric value or a symbol that is uniquely associated with each of the scopes. The status information 226 indicates whether the scope has been started or ended. In the present example, the status information 226 is represented by text of “ENTER” meaning start status and “LEAVE” meaning end status. The text is, however, illustrative and not limiting. The status information 226 may also, for example, be a numeric value or a symbol that is associated with the corresponding status. The status information 226 may also include information indicating, for example, another status, and a characteristic amount. The period information 227 indicates a sequence in which each scope becomes the start status or the end status. In the present example, the period information 227 is a numeric value assigned in ascending order. The numeric value is, however, illustrative and not limiting. The period information 227 may be a timestamp, for example.

The running information 221 allows a running period based on start timing and end timing of each scope to be identified, so that the inclusion relation of the scopes can be identified on the basis of the running period. For example, the running information 221 illustrated in FIG. 6 indicates that the running period of Scope_A is timing 1→8 and timing 3→4, and the running period of Scope_B is timing 2→5. The foregoing information reveals the following. Specifically, Scope_B is included in the first Scope_A and includes the second Scope_A. To state the foregoing differently, the function of Func_B is executed by being called by the first function of Func_A and the second function of Func_A is executed by being called by the function of Func_B.

It should be noted that, while FIG. 6 illustrates the running information 221 only for the high-order scopes 211, the running information for the low-order scopes 212 may also be similarly configured. The method of generating the running information described above is illustrative and not limiting. The running information for each of the high-order scopes 211 and the low-order scopes 212 may be generated using a well-known or novel technique, as appropriate.

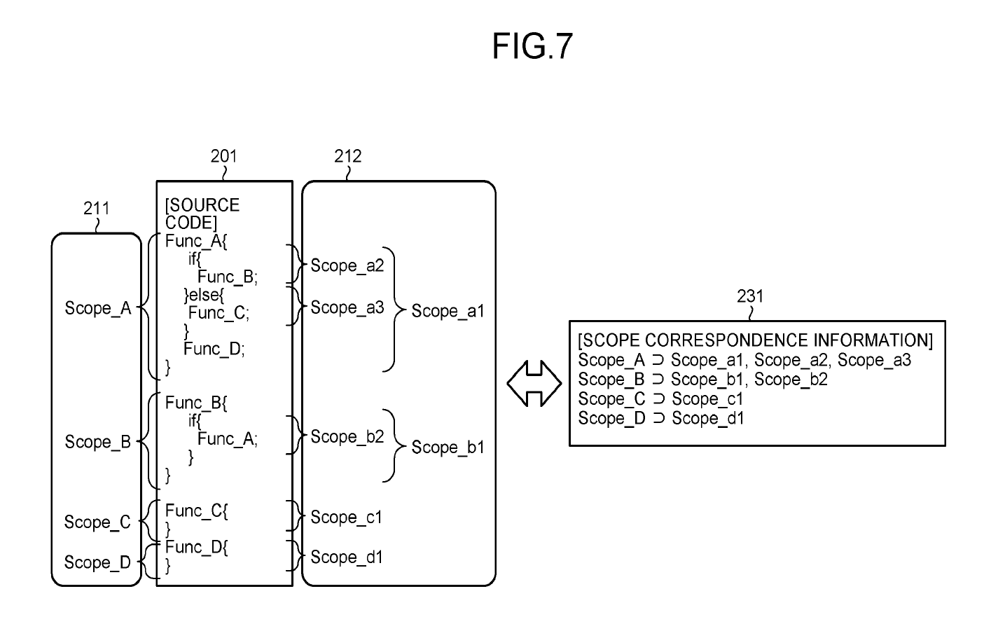

FIG. 7 is a diagram illustrating exemplary scope correspondence information 231. The scope correspondence information 231 indicates inclusion relations between the high-order scopes 211 and the low-order scopes 212. The scope correspondence information 231 illustrated in FIG. 7 indicates that the low-order scopes of Scope_a1, Scope_a2, and Scope_a3 are children scopes of the high-order scope of Scope_A (parent scope), the low-order scopes of Scope_b1 and Scope_b2 are children scopes of the high-order scope of Scope_B (parent scope), the low-order scope of Scope_c1 is a child scope of the high-order scope of Scope_C (parent scope), and the low-order scope of Scope_d1 is a child scope of the high-order scope of Scope_D (parent scope).

It should be noted that, in the scope correspondence information 231 illustrated in FIG. 7, text indicating the scope name, such as “Scope_A”, is used as information that identifies the specific scope. The configuration of the scope correspondence information 231 is, however, illustrative and not limiting and a numeric value or a symbol that is uniquely associated with each of the scopes may be used in place of the text. Additionally, the configuration of, and the method of generating, the scope correspondence information 231 should not be limiting and the scope correspondence information 231 may be generated using a well-known or novel technique, as appropriate.

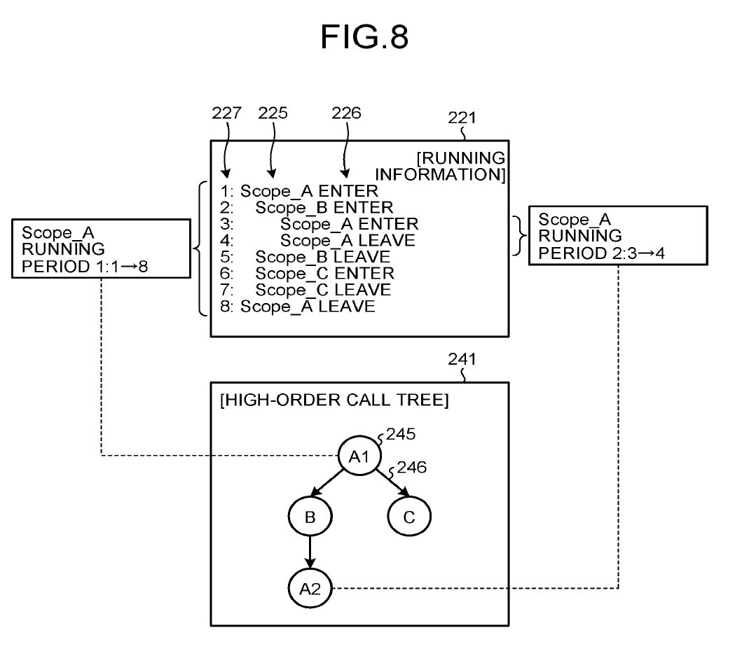

FIG. 8 is a diagram illustrating an exemplary high-order call tree 241. The high-order call tree 241 illustrated in FIG. 8 is generated on the basis of the running information 221 covering only the high-order scopes 211. The high-order call tree 241 includes a high-order node 245 associated uniquely with each of the high-order scopes 211 and an edge 246 that represents a directed segment connecting between the high-order nodes 245. A node (e.g., “A1”) connected with a proximal end side of the edge 246 is a parent node and a node (e.g., “B” and “C”) connected with a distal end side of the edge 246 is a child node. In the high-order call tree 241 illustrated in FIG. 8, the high-order scope 211: Scope_B is started (2) during the running period (1→8) of the high-order scope 211: Scope_A. Thus, the high-order node 245: “A1” corresponding to the high-order scope 211: Scope_A is a parent node and the high-order node 245: “B” corresponding to the high-order scope 211: Scope_B is a child node. In the high-order call tree 241 illustrated in FIG. 8, the high-order scope 211: Scope_A runs twice. The high-order node 245: “A1” corresponds to the high-order scope 211: Scope_A executed in the first run (running period 1→8) and the high-order node 245: “A2” corresponds to the high-order scope 211: Scope_A executed in the second run (running period 3→4).

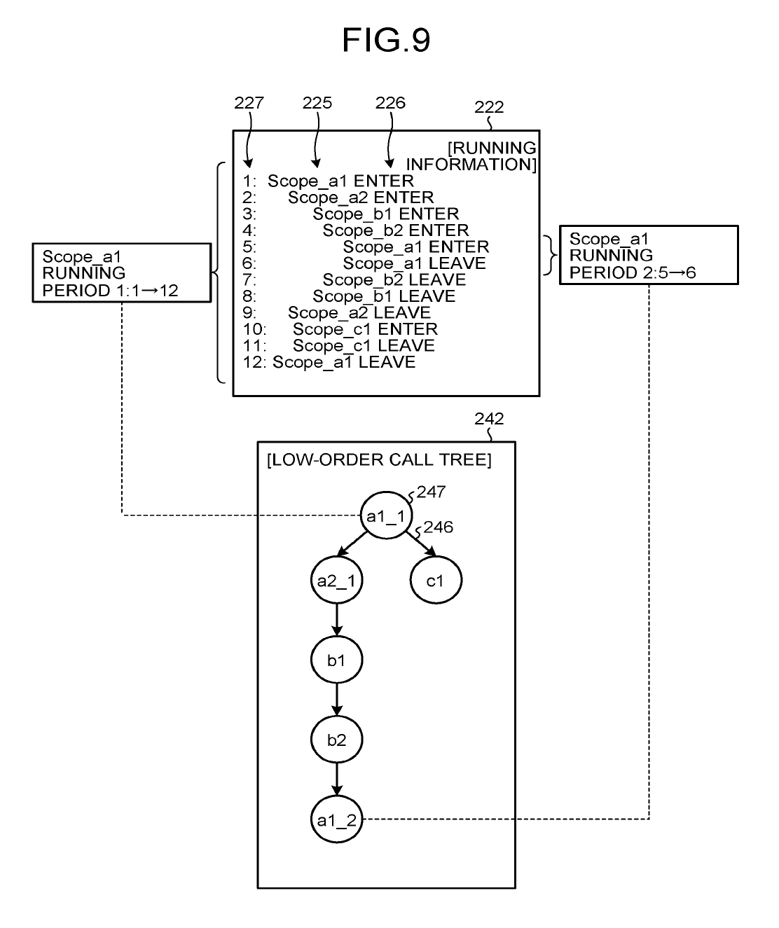

FIG. 9 is a diagram illustrating an exemplary low-order call tree 242. The low-order call tree 242 illustrated in FIG. 9 is generated on the basis of running information 222 covering only the low-order scopes 212. The running information 222 can be generated using a method identical to a method with which the running information 221 covering only the high-order scopes 211 illustrated in FIGS. 6 and 8 is generated. The low-order call tree 242 includes a low-order node 247 associated uniquely with each of the low-order scopes 212 and the edge 246 that represents a directed segment connecting between the low-order nodes 247. As in the high-order call tree 241 illustrated in FIG. 8, a node (e.g., “a1_1”) connected with a proximal end side of the edge 246 is a parent node and a node (e.g., “a2_1” and “c1”) connected with a distal end side of the edge 246 is a child node. In the low-order call tree 242 illustrated in FIG. 9, the low-order scope 212: Scope_a2 is started (2) during the running period (1→12) of the low-order scope 212: Scope_a1. Thus, the low-order node 247: “a1_1” corresponding to the low-order scope 212: Scope_a1 is a parent node and the low-order node 247: “a2_1” corresponding to the low-order scope 212: Scope_a2 is a child node. In the low-order call tree 242 illustrated in FIG. 9, the low-order scope 212: Scope_a1 runs twice. The low-order node 247: “a1_1” corresponds to the low-order scope 212: Scope_a1 executed in the first run (running period 1→12) and the low-order node 247: “a1_2” corresponds to the low-order scope 212: Scope_a1 executed in the second run (running period 5→6).

It should be noted that the high-order call tree 241 and the low-order call tree 242 are illustrative and not limiting and may be generated using a well-known or novel technique, as appropriate. FIGS. 8 and 9 illustrate examples in which the high-order call tree 241 and the low-order call tree 242 are generated on the basis of two different pieces of running information (the running information 221 covering only the high-order scopes 211 and the running information covering only the low-order scopes 212). It is nonetheless possible to generate the high-order call tree 241 and the low-order call tree 242 on the basis of a single piece of running information that covers both the high-order scopes 211 and the low-order scopes 212 (information indicating statuses of the high-order scopes 211 mixed with information indicating statuses of the low-order scopes 212).

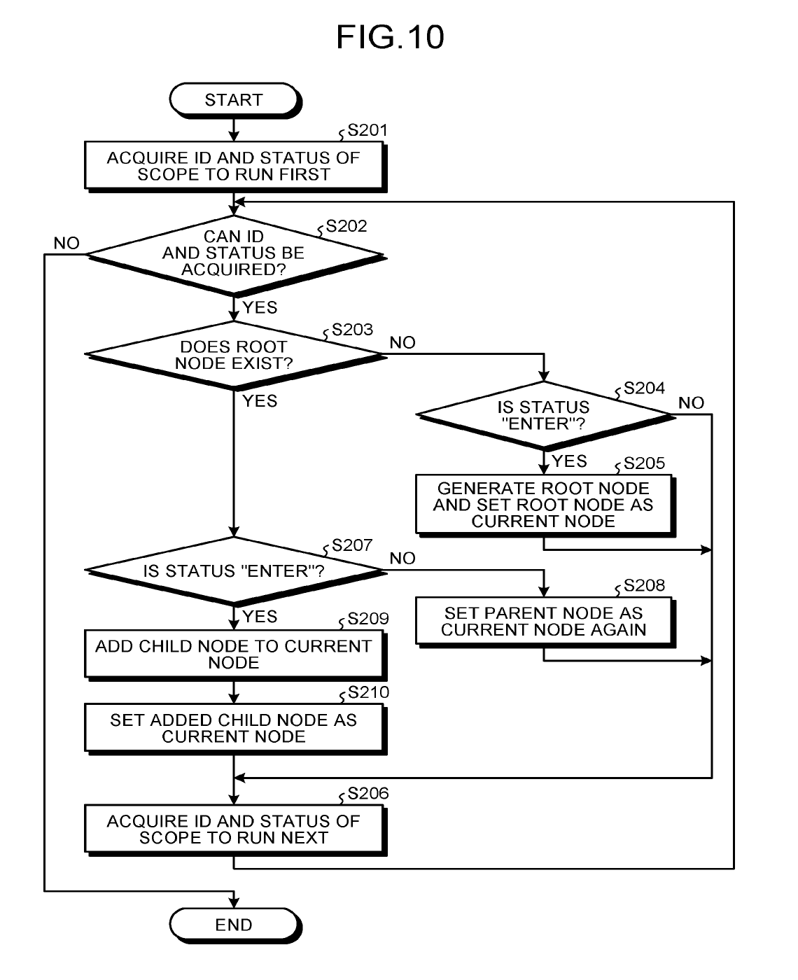

FIG. 10 is a flowchart illustrating an exemplary procedure for generating the high-order call tree 241 or the low-order call tree 242. In the example illustrated in FIG. 10, the call tree generation unit 102 reads in sequence a run of each of the high-order scopes 211 and the low-order scopes 212 from the running information 221 and the running information 222 and extracts the inclusion relation between the high-order scopes 211 and the low-order scopes 212, thereby generating the high-order call tree 241 and the order call tree 242.

The call tree generation unit 102 acquires the scope ID 225 and the status information 226 of the scope that runs first, among the high-order scopes 211 and the low-order scopes 212, on the basis of the running information 221 and the running information 222 (S201). If the scope ID 225 and the status information 226 are not acquired (No at S202), this routine is terminated. If the scope ID 225 and the status information 226 are acquired (Yes at S202), it is then determined whether a root node exists (S203). The root node assumes a base point for generating the high-order call tree 241 and the low-order call tree 242.

If it is determined at Step S203 that the root node does not exist (No at S203), it is then determined whether the acquired status information 226 is “ENTER” (S204). If the acquired status information 226 is “ENTER” (Yes at S204), the node that corresponds to the scope, among the high-order scopes 211 and the low-order scopes 212, indicated by the acquired scope ID 225 is generated as the root node and the generated node is set as a current node (S205). The current node is a parent node set when a new child node is to be added. The scope ID 225 and the status information 226 of a new scope that runs next, among the high-order scopes 211 and the low-order scopes 212, is thereafter acquired from the running information 221 and the running information 222 (S206). Step S206 is performed even if it is determined at Step S204 that the acquired status information 226 is not “ENTER” (that is, the status information 226 is “LEAVE”) (No at S204).

If it is determined at Step S203 that the root node exists (Yes at S203), it is then determined whether the newly acquired status information 226 is “ENTER” (S207). If it is determined that the newly acquired status information 226 is “ENTER” (Yes at S207), the node corresponding to the scope, among the high-order scopes 211 and the low-order scopes indicated by the newly acquired scope ID 225 is added as child note with respect to the node (parent node) set as the current node (S209). The added child node is thereafter set as a current node (S210) and the scope ID 225 and the status information 226 of the scope that runs next, among the high-order scopes 211 and the low-order scopes 212, are acquired (S206). If it is determined at Step S207 that the status information 226 is not “ENTER” (that is, the status information 226 is “LEAVE”) (No at S207), the parent node of the current node is set again as a new current node (S208) and Step S206 is performed.

Performance of the above procedure for each of the running information 221 that covers only the high-order scopes 211 and the running information 222 that covers only the low-order scopes 212 enables the high-order call tree 241 and the low-order call tree 242 to be generated. If the running information to be used mixes the running sequence of the high-order scopes 211 with the running sequence of the low-order scopes 212, at Step S206 in which the scope ID 225 and the status information 226 of the scope that runs next, among the high-order scopes 211 and the low-order scopes 212, are acquired, only information on a target level's scopes (e.g., the high-order scopes 211) should be acquired, and information on a non-target level's scopes (e.g., the low-order scopes 212) should not be acquired.

The node information generation unit 103 generates the node correspondence information that indicates correspondence between the high-order nodes 245 and the low-order nodes 247 on the basis of the high-order call tree 241 and the low-order call tree 242 generated as described above, and the scope correspondence information 231 described above.

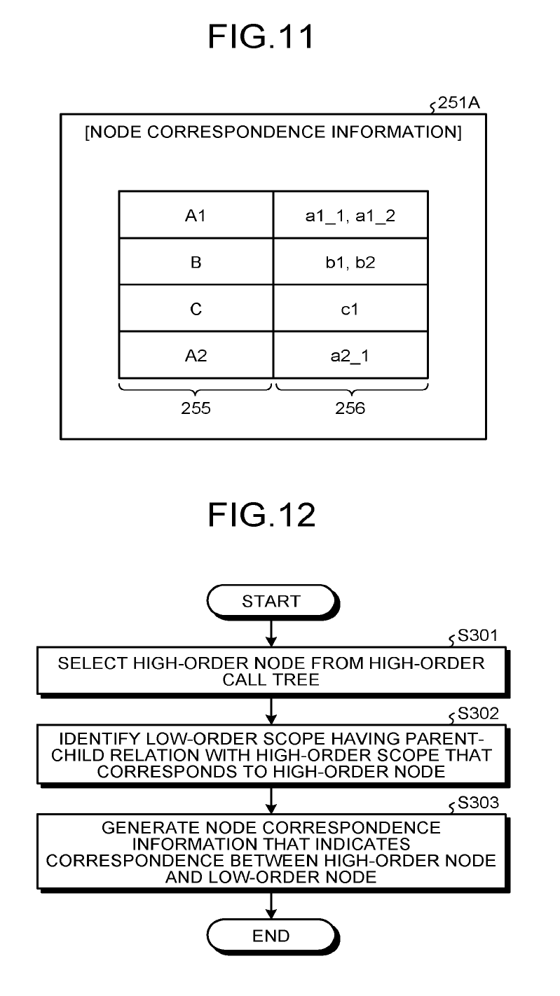

FIG. 11 is a diagram illustrating exemplary node correspondence information 251A in a first example of the first embodiment. The node correspondence information 251A in the present example is information of a tabular format including a high-order node display portion 255 and a low-order node display portion 256. The high-order node display portion 255 displays information (A1, B, C, A2) that identifies the high-order nodes 245 that constitute the high-order call tree 241. The low-order node display portion displays information (a1_1, a1_2, b1, b2, c1, a2_1) that identifies the low-order nodes 247 that constitute the low-order call tree 242. The node correspondence information 251A in the present example displays the high-order node 245 and the low-order node 247 that have correspondence with each other on an identical line. For example, the first line of the node correspondence information 251A indicates that the high-order node 245: A1 has a parent-child relation with each of low-order nodes 247: a1_1 and a1_2. The node correspondence information 251A tabulated in the foregoing manner enables correspondence between two different high-order call tree 241 and low-order call tree 242 generated from a single piece of source code 201 to be determined.

FIG. 12 is a flowchart illustrating an exemplary procedure for generating the node correspondence information 251A in the first embodiment. The node information generation unit 103 selects the high-order node 245 from the high-order call tree 241 (S301). This selection is performed in accordance with a predetermined rule by the CPU 21 that operates in accordance with the control program stored in the ROM 22. For example, all high-order nodes 245 included in the high-order call tree 241, the high-order nodes 245 specified by the user via the input device 24, and the high-order nodes 245 that comply with a predetermined condition are selected.

The node information generation unit 103 uses the scope correspondence information 231 to identify the low-order scopes 212 that have the inclusion relation with the high-order scopes 211 corresponding to the selected high-order nodes 245 (S302). For example, on the basis of the first line of the scope correspondence information 231 illustrated in FIG. 7, it is identified that the high-order scope 211: “Scope_A” has a parent-child relation with the two low-order scopes 212: “Scope_a1” and “Scope_a2”.

It should be noted that the scope correspondence information 231 described above is illustrative and not limiting and may be generated according to the selected high-order nodes 245 as appropriate. For example, the scope correspondence information according to the selected high-order nodes 245 may be generated as appropriate by identifying running periods of the high-order scopes 211 corresponding to the selected high-order nodes 245 on the basis of the running information 221 of the high-order scopes 211 as illustrated in FIG. 8 and identifying the low-order scopes 212 that ran during the identified running periods on the basis of the running information 222 of the low-order scopes 212 as illustrated in FIG. 9.

The node information generation unit 103 generates the node correspondence information 251A that indicates the correspondence between the selected high-order nodes 245 and the low-order nodes 247 corresponding to the identified low-order scopes 212 (S303).

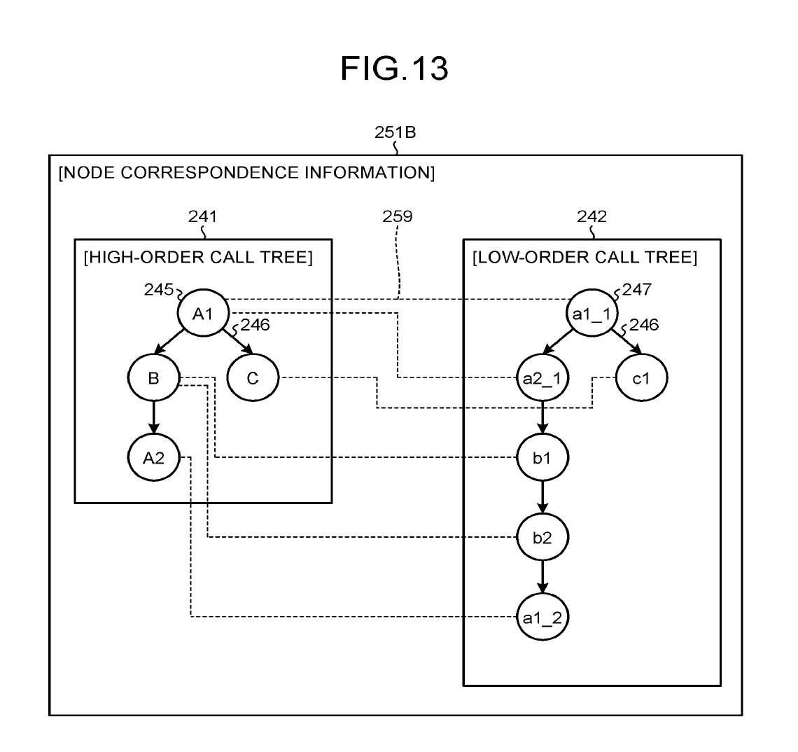

FIG. 13 is a diagram illustrating exemplary node correspondence information 251B in a second example of the first embodiment. The node correspondence information 251B in the second example includes the high-order call tree 241, the low-order call tree 242, and correspondence lines 259. In the second example, the high-order call tree 241 and the low-order call tree 242 are displayed in parallel with each other and the high-order node 245 and the low-order node 247 having a parent-child relation with each other are connected with each other by the correspondence line 259.

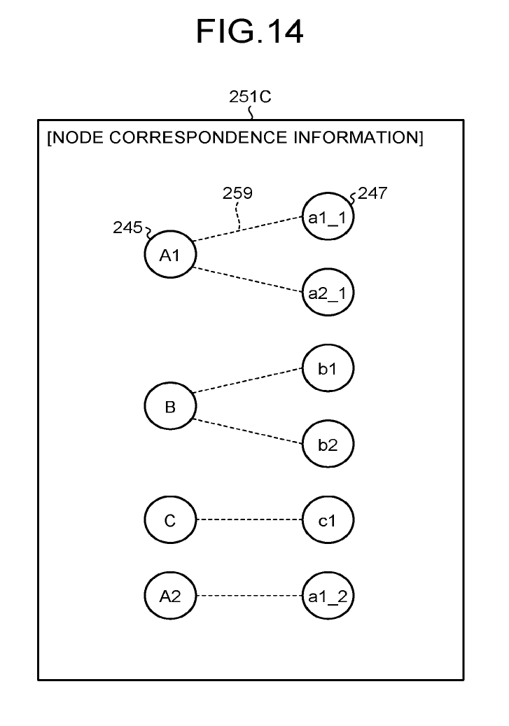

FIG. 14 is a diagram illustrating exemplary node correspondence information 251C in a third example of the first embodiment. The node correspondence information 251C displays only the high-order nodes 245 and the low-order nodes 247 having a parent-child relation therebetween, excerpted from the high-order call tree 241 and the low-order call tree 242.

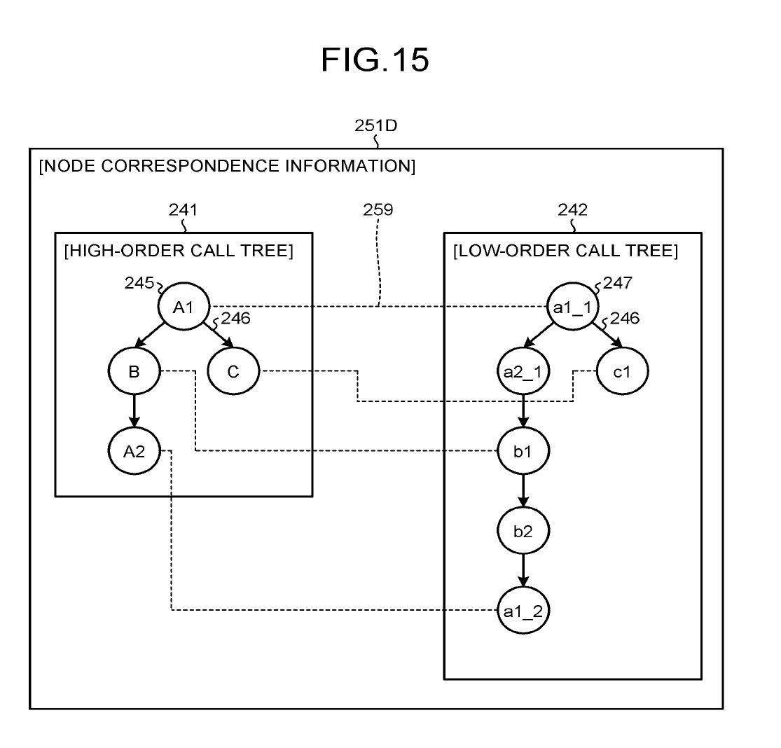

FIG. 15 is a diagram illustrating exemplary node correspondence information 251D in a fourth example of the first embodiment. The node correspondence information 251D in the fourth example differs from the node correspondence information 251D illustrated in FIG. 13 in that the correspondence line 259 connecting the high-order node 245: A1 with the low-order node 247: a2_1 and the correspondence line 259 connecting the high-order node 245: B with the low-order node 247: b2 are not displayed. In the fourth example, when one high-order node 245 has a parent-child relation with a plurality of low-order nodes 247 (one high-order scope 211 includes a plurality of low-order scopes 212), the node correspondence information 251D displays only the correspondence line 259 associated with a low-order node 247 that satisfies a predetermined condition. Examples of the predetermined condition include, but are not limited to, the longest running period among the applicable low-order scopes 212. This arrangement prevents information indicating correspondence, including the correspondence line 259, from being excessively displayed, so that the correspondence between the high-order node 245 and the low-order node 247 can readily be determined.

The node correspondence information 251A to 251D generated as described above may be used for a variety of purposes. For example, the node correspondence information 251A to 251D may be directly output to, for example, a computer display or provided for other systems. Examples of the other systems include, but are not limited to, a system that visualizes the status of execution of a program using a graphical user interface (GUI) and a system that verifies the source code 201.

The first embodiment has been described for a case in which the two call trees 241 and 242 having different hierarchical levels are generated from the single piece of source code 201. The embodiment is, however, illustrative only and not limiting. Even when three or more call trees having different hierarchical levels or an identical hierarchical level are to be generated, node correspondence information indicating correspondence among a plurality of nodes that constitute the call trees can be generated.

The hardware configurations illustrated in FIGS. 1 and 2 are illustrative only and the program information generation system 1 can be achieved through various hardware configurations. For example, the program information generation system 1 may be formed of a standalone general-purpose computer or a dedicated system including a built-in processor.

FIG. 3 illustrates the program information generation system 1 including its most fundamental functional blocks of the acquisition unit 101, the call tree generation unit 102, and the node information generation unit 103 connected in order of processing. The configuration is, however, illustrative only and may, for example, be a configuration in which the functional blocks operate parallelly in a coordinated manner, a configuration in which the functional blocks are connected in a different order, a configuration in which one functional block is divided into a plurality of functional blocks, and a configuration combining the foregoing three.

The control program that achieves the functions of the program information generation system 1 can be provided by being recorded in a computer-readable recording medium such as a compact disc read only memory (CD-ROM), a flexible disk (FD), a compact disc recordable (CD-R), and a digital versatile disc (DVD), as an installable or executable file. The control program may be provided by being downloaded from a predetermined storage device connected to a network in a predetermined computer or provided for a predetermined information processing apparatus by being incorporated in, for example, a ROM in advance. The control program may be formed of a plurality of modules that achieve the functions of the acquisition unit 101, the call tree generation unit 102, and the node information generation unit 103.

In accordance with the program information generation system 1 described above, when the high-order call tree 241 and the low-order call tree 242 having different hierarchical levels are generated from the single source code 201, the node correspondence information 251A to 251B that indicate the correspondence among the high-order nodes 245 and the low-order nodes 247 that constitute the high-order call tree 241 and the low-order call tree 242 are generated. This capability enables the correspondence among the call trees 241 and 242 to be readily and precisely determined.

The following describes miscellaneous embodiments with reference to the accompanying drawings. Like or corresponding parts may be identified by the same reference numerals as those used in the first embodiment and descriptions for those parts may be omitted.

### Second Embodiment

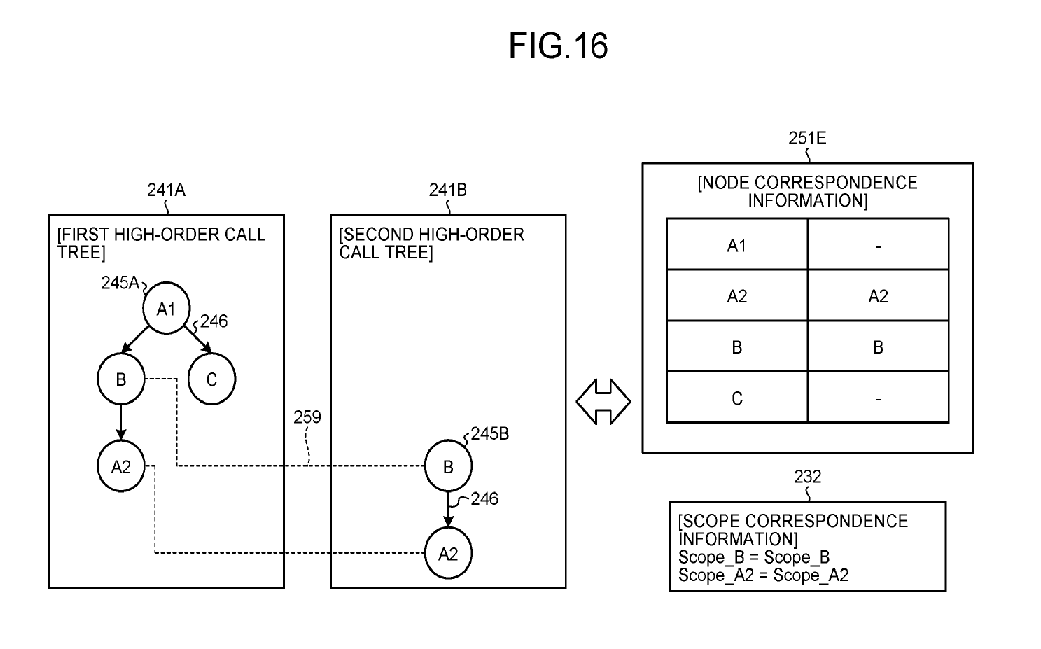

FIG. 16 is a diagram illustrating exemplary first high-order call tree 241A, second high-order call tree 241B, scope correspondence information 232, and node correspondence information 251E generated by a program information generation system 1 according to a second embodiment.

A call tree generation unit 102 in the second embodiment generates the two high-order call trees 241A and 241B from a single piece of running information 221. The first high-order call tree 241A is identical to the high-order call tree 241 in the first embodiment described previously. The second high-order call tree 241B constitutes part of the first high-order call tree 241A. To state the foregoing differently, the running periods of high-order scopes 211 corresponding to all second high-order nodes 245B that constitute the second high-order call tree 241B are included in the running periods of the high-order scopes 211 corresponding to all first high-order nodes 245A that constitute the first high-order call tree 241A. The scope correspondence information 232 in the present example illustrated in FIG. 16 indicates the correspondence between the high-order scope 211 corresponding to the first high-order node 245A and the high-order scope 211 corresponding to the second high-order node 245B.

A node information generation unit 103 in the second embodiment generates the node correspondence information 251E on the basis of the first high-order call tree 241A, the second high-order call tree 241B, and the scope correspondence information 232 described above. The node correspondence information 251B in the present example illustrated in FIG. 16 indicates the correspondence between the first high-order nodes 245A and the second high-order nodes 245B. Additionally, in the first high-order call tree 241A and the second high-order call tree 241B, correspondence lines 259 connect between the respective first high-order nodes 245A and the respective second high-order nodes 245B that are associated with each other. It should be noted that, as with the node correspondence information 251A to 251B in the first embodiment, information that indicates correspondence with the low-order node 247 may be additionally generated.

As described above, a plurality of call trees having an identical hierarchical level may be generated and node correspondence information indicating correspondence among a plurality of nodes that constitute these call trees may be generated. Thus, not only the correspondence between the call trees having different hierarchical levels, but also the correspondence between call trees having an identical hierarchical level can be readily and precisely determined.

### Third Embodiment

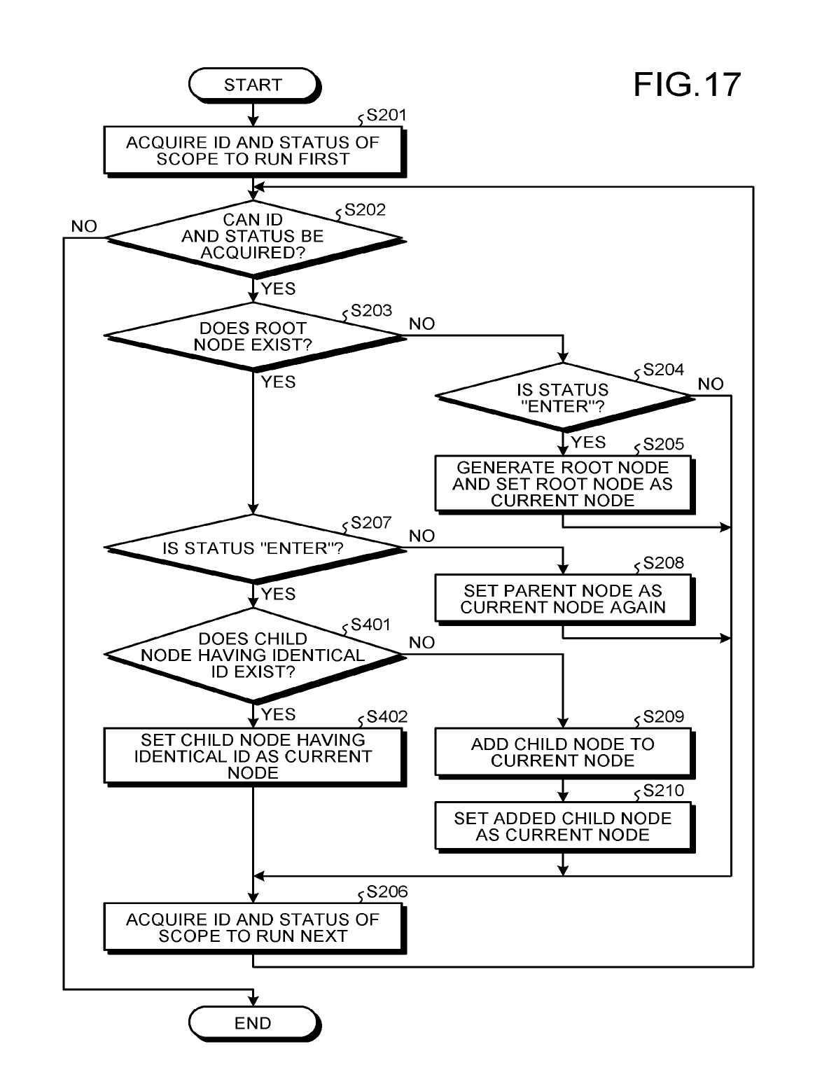

FIG. 17 is a flowchart illustrating an exemplary procedure for generating a high-order call tree 241 or a low-order call tree 242 in a third embodiment. The flowchart in the third embodiment illustrated in FIG. 17 differs from the flowchart in the first embodiment illustrated in FIG. 10 in that the flowchart of the third embodiment includes Step S401 and Step S402. In the third embodiment, a node may not be newly added when the status is “ENTER” at Step S207, specifically, newly acquired status information 226 is “ENTER” (Yes at S207).

In the third embodiment, if the newly acquired status information 226 is “ENTER” (Yes at S207), it is determined whether a child node that corresponds to the high-order scopes 211 and the low-order scopes 212 indicated by a scope ID 225 identical to the newly acquired scope ID 225 exists within the high-order call tree 241 and the low-order call tree 242 (S401).

If it is determined at Step S401 that a child node that corresponds to the high-order scopes 211 and the low-order scopes 212 indicated by the identical scope ID 225 exists (Yes at S401), the child node in question is set as the current node (S402). This setting results in a single node indicating a plurality of running periods.

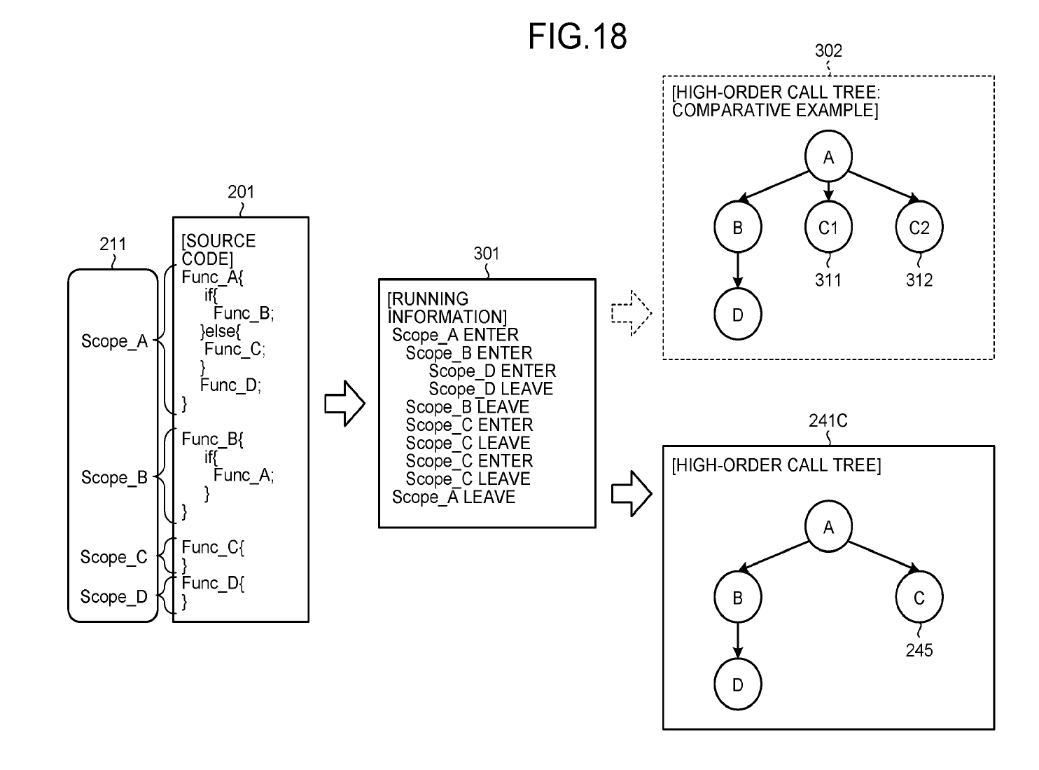

FIG. 18 is a diagram illustrating an exemplary high-order call tree 241C generated in the third embodiment. The high-order call tree 241C illustrated in FIG. 18 is generated through the flowchart illustrated in FIG. 17 on the basis of running information 301 in the present example. A high-order call tree 302 illustrated in FIG. 18 serves as a comparative example generated through the flowchart illustrated in FIG. 10 using the running information 301.

In the present example, the high-order scope 211: Scope_C is run twice during the running period of the high-order scope 211: Scope_A as illustrated in the running information 301. On the basis of this running information 301, a high-order node 311: C1 corresponding to the high-order scope 211: Scope_C during its first run and a high-order node 312 corresponding to the high-order scope: Scope_C during its second run are individually generated in the high-order call tree 302 as the comparative example. In contrast, in the high-order call tree 241C in the third embodiment, only one high-order node 245: C corresponding to the high-order scope 211: Scope_C is generated. This is attributable to the following reason: specifically, because of Step S401 and Step S402 in FIG. 17, the child node corresponding to the high-order scope 211: Scope_C in its second run (high-order node 312: C2) has not been added.

This arrangement enables reduction in the number of nodes, so that, for example, the correspondence among a plurality of call trees can be determined, a volume of information can be reduced, and processing load can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program information generation system, comprising:
a processor configured to be controlled by a program;
an acquisition unit configured to be implemented by the processor and acquire running information that indicates an execution sequence of a plurality of scopes set within source code and scope correspondence information that indicates an inclusion relation among the scopes;
a call tree generation unit configured to be implemented by the processor and generate, based on the running information, a first call tree including at least one first nodes associated with at least one first scopes and a second call tree including at least one second nodes associated with at least one second scopes that is different from the first scopes from a single piece of the source code; and
a node information generation unit configured to be implemented by the processor and generate, based on the scope correspondence information, the first call tree, and the second call tree, node correspondence information that indicates correspondence between the first node and the second node.

2. The program information generation system according claim 1, wherein a hierarchical level of the first scope and a hierarchical level of the second scope are different from each other.

3. The program information generation system according to claim 1, wherein
there is no scope that includes the first scope, and
there is a scope that includes the second scope.

4. The program information generation system according to claim 3, wherein the node correspondence information associates the first node corresponding to the first scope with the second node corresponding to the second scope included in the first scope.

5. The program information generation system according to claim 1, wherein the first scope is delimited by a function.

6. The program information generation system according to claim 5, wherein the second scope is delimited by loop processing or branch processing within the function.

7. The program information generation system according to claim 1, wherein, when a plurality of the second nodes that are associated with the first node exist, the node information generation unit generates the node correspondence information such that only the second node that satisfies a predetermined condition is associated with the first node.

8. The program information generation system according to claim 7, wherein the predetermined condition is a maximum operating period exhibited by one of the second scopes corresponding to the second node.

9. The program information generation system according claim 1, further comprising a display unit configured to visualize the node correspondence information.

10. A method for generating program information, the method comprising:
acquiring running information that indicates an execution sequence of a plurality of scopes set within source code and scope correspondence information that indicates an inclusion relation among the scopes;
generating, based on the running information, a first call tree including at least one first nodes associated with at least one first scopes and a second call tree including at least one second nodes associated with at least one second scopes that is different from the first scopes from a single piece of the source code; and
generating, based on the scope correspondence information, the first call tree, and the second call tree, node correspondence information that indicates correspondence between the first node and the second node.

11. A computer program product for generating program information, the computer program product having a non-transitory computer readable medium including programmed instructions, wherein the instructions, when executed by a computer, cause the computer to perform:
acquiring running information that indicates an execution sequence of a plurality of scopes set within source code and scope correspondence information that indicates an inclusion relation among the scopes;
generating, based on the running information, a first call tree including at least one first nodes associated with at least one first scopes and a second call tree including at least one second nodes associated with at least one second scopes that is different from the first scopes from a single piece of the source code; and
generating, based on the scope correspondence information, the first call tree, and the second call tree, node correspondence information that indicates correspondence between the first node and the second node.
